(19) United States
(12) Patent Application Publication
(10) Pub. No.: US 2026/0146474 A1
(43) Pub. Date: May 28, 2026

(54) MAGNETIC ACTUATED COUPLING DEVICE

(71) Applicant: Raytheon Company, Arlington, VA (US)

(72) Inventor: Joseph M. Misulia, ATTLEBORO, MA (US)

(21) Appl. No.: 18/961,022

(22) Filed: Nov. 26, 2024

(51) Int. Cl. E05B 47/00

(52) U.S. Cl. CPC E05B 47/004

(57) ABSTRACT

A system for connecting a coupling cover with a hull shell can include a magnetic actuated latch. The system can include a shell architecture positioned within the hull shell. The shell architecture can include a chassis extending within the hull shell and a chassis clasp extending from the chassis. The magnetic actuated latch 205 can also include a locking plate configured to be movably coupled with the coupling cover. The locking plate can include a locking catch recess formed in the locking plate and the locking catch recess is configured to receive the chassis clasp and a magnetically responsive actuator coupled with the locking plate.

### BACKGROUND

In some examples, a hull is a watertight enclosure designed to protect a payload, such as cargo, machinery, electronics, or the like. The hull can safeguard the payload against external environmental conditions including, for example, moisture, particulates, air or the like. The hull can also be designed to protect the payload from structural damage.

The hull can incorporate a complex assortment of parts that are coupled together. The hull can include a cavity that houses the payload. For example, the payload, such as electronics, machinery, cargo or the like, can be inserted or positioned within the hull through an opening. The opening can be closed and optionally sealed with a cap. The cap, in some examples can be threaded or fastened with one or more fasteners onto the body of the hull.

In some examples, the hull is formed from materials that can withstand the environment the hull will be exposed to. For example, the hull can be designed to withstand pressures greater than the air or water pressure at sea-level. The hull can also be designed to withstand temperature fluctuations, harsh environmental conditions or the like. To withstand the environment, materials such as titanium, nickel alloys or the like can be used to form the hull.

### SUMMARY

A hull can include a sealed structure that can provide protection to enclosed components. A hull can be a structure that minimizes environmental elements, such as moisture, particulates or gases from entering the structure. For example, a hull is a watertight enclosure that provides protection for cargo, machinery, electronics, or the like. Hulls can include covers coupled with at least one opening of the hull. For example, the hull can be a cylindrical structure with at least one opening on an end of the cylinder. A cover can couple with the hull. The cover can be coupled with the hull to seal the internal structures and components housed within the hull.

A magnetic actuated coupling latch can be coupled with a coupling cover. A locking plate can be coupled with the coupling cover. The locking plate can include a locking catch recess formed within a portion of the locking plate. A magnetically responsive actuator can be coupled to a portion of the locking plate. A chassis clasp can mate with the locking catch recess. The magnetic actuated coupling can include a biasing element coupled with a portion of the locking plate remote from the magnetically responsive actuator. The locking plate can transition from a released configuration to a locked configuration with an application of a magnetic force to the magnetically responsive actuator. In an example, in the released configuration, the chassis clasp can be disconnected from the locking catch. In the locked configuration, the magnetically responsive actuator can cause the position of the locking plate to shift. In the locked configuration, the locking plate can shift to engage the locking catch recess with the chassis clasp.

### BRIEF DESCRIPTION OF THE DRAWINGS

FIG. 1 illustrates a perspective view of an autonomous vehicle include a hull shell according to at least one example of the present disclosure.

FIG. 2A illustrates an example of a hull according at least one example of the present disclosure.

FIG. 2B illustrates an example of a shell architecture according to at least one example of the present disclosure.

FIG. 3 illustrates a system for connecting a coupling cover according to at least one example of the present disclosure.

FIG. 4 illustrates a system for connecting a coupling cover according to at least one example of the present disclosure.

FIG. 5 illustrates a system for connecting a coupling cover according to at least one example of the present disclosure.

FIG. 6 illustrates a cross section of a system for connecting a coupling cover according to at least one example of the present disclosure.

FIG. 7A illustrates a released configuration of a system for connecting a coupling cover according to at least one example of the present disclosure.

FIG. 7B illustrates a locked configuration of a system for connecting a coupling cover according to at least one example of the present disclosure.

### DETAILED DESCRIPTION

Vehicles, both autonomous and manually controlled, include external structures that can be designed to protect internal components within the vehicle. The hull can have sensitive components positioned or placed inside of the hull. The sensitive components can be damaged, destroyed or made inoperable if exposed to environmental conditions. Hulls can include a hull shell that envelops the sensitive components. Hulls can also include covers (e.g., caps, portals or the like) that can be positioned or coupled relative to an opening of the hull shell to protect the sensitive components. The covers can be coupled with the hull shell to provide a sealed structure.

Covers can be coupled with an opening of the hull shell with a mechanical means such as threading, fasteners or the like. Covers can also be coupled with an opening of the hull shell with adhesives, welding or the like. In some examples, the covers are coupled to be resistant to high pressures. Covers that benefit from being resistant to high pressures can include additional coupling features, such as additional threading, fasteners, adhesives or the like to enhance the strength of coupling.

Hulls that can be subjected to high pressures (e.g., pressures greater than 100,000 kPa) can be formed from uncommon materials such as titanium, nickel alloys and other composites that can withstand the high pressure. Forming a hull from uncommon materials can present technical or fabrication challenges. For example, adding fastening features to hulls (including one or both of the hull shell or the cover) formed from exotic materials can induce stress risers or increase the frequency of crack initiation sites. In other examples, adding internally threaded features to one or both of the cover or the hull shell can be challenging or can form an unreliable connection.

A coupling that can be used with the uncommon materials while minimizing additional manufacturing to the hull shell or the cover can include adding a magnetically actuated hull coupling system as described below. In the examples described below, the hull shell can be formed of a simple elongated cylinder or tube. The hull shell described below can have a reduced weight as compared to hull shells that implement additional fastening features or require additional components to avoid additional stress or failures.

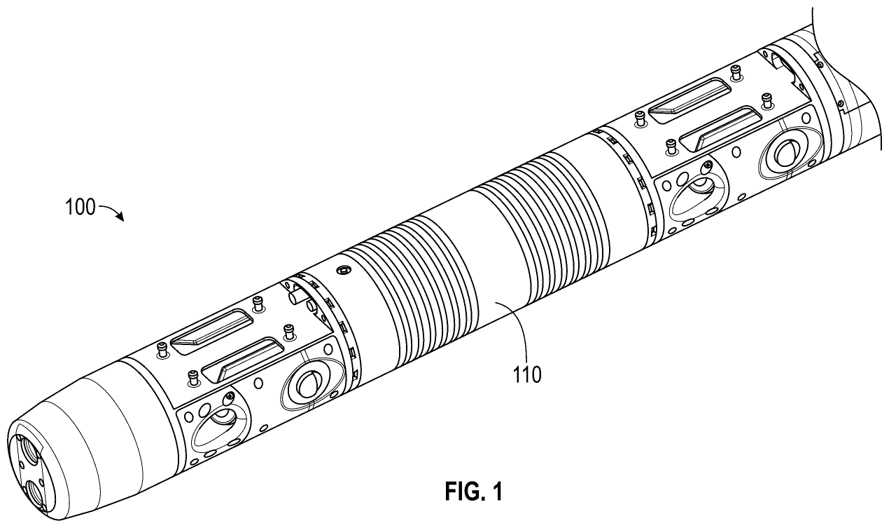

FIG. 1 illustrates a vehicle 100 that includes a hull shell 110. In an example, the hull shell 110 can be a series of hull shells positioned to adjacent hull shells or a single hull shell. In an example, the hull shell 110 can be coupled (e.g., joined, bonded, welded or the like) with adjacent hull shells. The hull shell 110 can be a component of the autonomous vehicle 100 that is interposed between other systems or connected with additional hull shells. In an example, the vehicle 100 can be an autonomous vehicle such as an unmanned underwater vehicle. The vehicle 100, as an unmanned underwater vehicle, can be a vehicle that can be subjected to deep water submergence missions. The vehicle 100 including hull 200 can be used in deep ocean locations (e.g., locations greater than 1000 meters under the surface of the water). In another example, the vehicle 100 can be a manually controlled vehicle or a remotely controlled vehicle that also can be used in deep ocean locations. Optionally, the vehicle 100 can be an aeronautic vehicle or a terrestrial vehicle that can be subjected to high pressure environments. The concepts described herein can be applicable to vehicles, systems or the like that can encounter high pressures and can benefit from simple designs while reducing the complexity of the fasteners to hold, for example, covers (e.g., caps, enclosures, portals or the like) to a body of the hull shell 110.

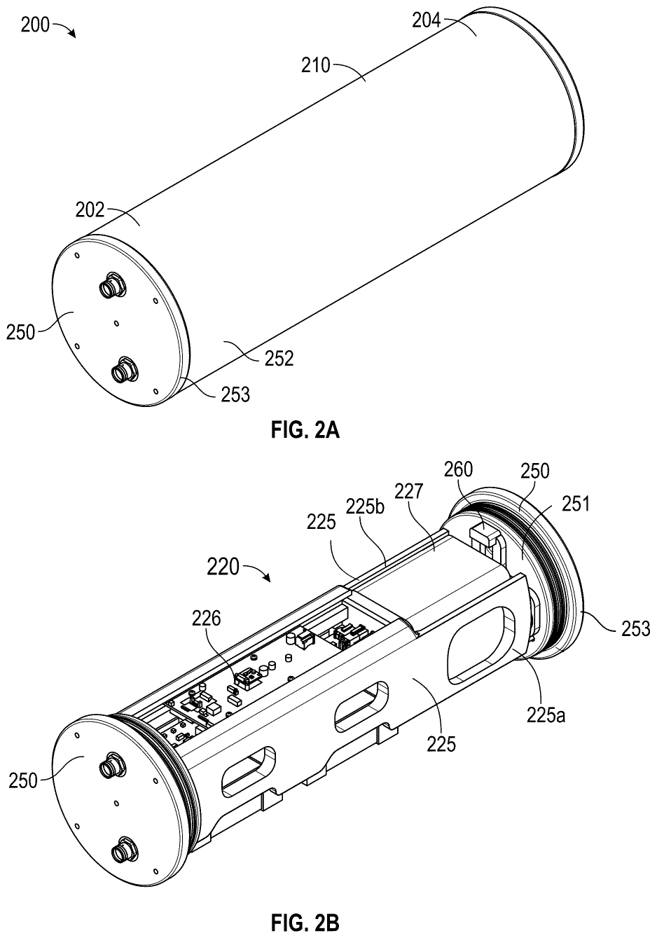

FIG. 2A illustrates an example of a hull 200 as a component of a vehicle, such as vehicle 100, discussed related to FIG. 1. The hull 200 can include a hull shell 210. The hull shell 210 can have a cylindrical or tubular form, or other forms suitable for the purpose. The hull shell 210 can extend from a first end 202 to a second end 204. The hull shell 210 can be a continuous structure that can protect internal components from environmental matter (e.g., moisture, particulates, temperature fluctuations, gases or the like). The hull shell 210 can be a component of the hull 200 that can seal internal components within the hull 200.

The hull shell 210 can be formed from a non-ferrous material. The hull shell 210 can be formed from materials, such as titanium, stainless steel, carbon composites or the like. The hull shell 210 can be formed from one or more materials that can exhibit reduced weight, structural strength and are low in cost.

The hull shell 210 can include a coupling cover 250. The hull shell 210 can have a coupling cover 250 positioned on (e.g., including inserted partially into, coupled around, positioned at least partially on) at least one of the first end 202 or the second end 204 of the hull shell 210. The coupling cover 250 can be an end cap of the hull 200. The coupling cover 250 can be positioned on the first end 202 or the second end 204 to seal the hull shell 210. The coupling cover 250 can include external coupling features to couple the hull 200 with further coupled with other components, such as other structures of the vehicle 100.

The coupling cover 250 can have a form that is similar in diameter or width to the hull shell 210. The coupling cover 250 can have a shape that can correspond to the hull shell 210. The coupling cover 250 can be approximately circular, elliptical, rounded or the like. The coupling cover 250 can have a shape that reduces stresses that can form at areas where the geometry of the coupling cover 250 changes. The coupling cover 250 can be formed to have an outer perimeter 253 that substantially matches an outer perimeter 252 of the hull shell 210. For example, the coupling cover 250 when coupled with the hull shell 210 forms a smooth or continuous surface. In an example, the coupling cover 250 can be coupled with the hull shell 210 on one side and can be coupled (e.g., joined, bonded, welded or the like) with an adjacent hull shell, or other components. In an example, the adjacent hull shell can be similarly coupled with the coupling cover 250 as described below.

Illustrated in FIG. 2B is an example of a shell architecture 220. The shell architecture 220 can include the internal components of the hull 200, discussed related to FIG. 2A. The shell architecture 220 can include structural components such as a chassis 225. The shell architecture 220 can also include payloads, electronic components, computer systems, mechanical systems or the like. The chassis 225 can include the framework that surrounds, supports, envelopes, or the like the internal components of the shell architecture 220. For example, the chassis 225 can support electronic components 226 or payloads 227. The chassis 225 can also support other components as specified by the use.

The chassis 225 can extend substantially the length of the hull shell 210 (illustrated and discussed related to FIG. 2A). The chassis 225 can be positioned between the first end 202 and the second end 204 of the hull shell 210 (as illustrated and discussed related to FIG. 2A). The chassis 225 can have a width dimension that is similar to the diameter or width of the hull shell 210. The chassis 225 can also have a width dimension that is less than the hull shell 210. In an example, the chassis 225 can have a width dimension that is less than an internal side 251 of the coupling cover 250.

The chassis 225 can have a first brace 225a and a second brace 225b. The first brace 225a and the second brace 225b can be formed in shapes and profiles that are suitable for the use. The chassis 225 can also include more than two braces. The chassis 225 can include one brace that continues within the shell architecture 220. For example, the chassis 225 can include a brace that is similar is shape to the hull shell 210 (as illustrated and discussed related to FIG. 2A). The first brace 225a and the second brace 225b can be spaced from each other within the shell architecture 220 a specified distance to support the internal components such as electronic components 226, payloads 227 or the like.

The chassis 225 can extend within the shell architecture 220 and can be implemented to connect the coupling cover 250 to at least one of the first end 202 or the second end 204 of the hull shell 210. For example, the chassis 225 can couple with the internal side 251 of the coupling cover 250. A locking plate 270 can be coupled with the internal side 251 of the 250. The locking plate 270 can be positioned to couple the first brace 225a and the second brace 225b on opposing sides of the locking plate 270.

Positioned on the locking plate 270 can be a magnetically responsive actuator 260. The magnetically responsive actuator 260 can be a materially that exhibits magnetic field properties. For example, the magnetically responsive actuator 260 can be formed from a ferrous material, such as iron, nickel, cobalt, alloys or the like. The magnetically responsive actuator 260 can be formed from a material that exhibits electromagnetic properties. The magnetically responsive actuator 260 can be formed from a block, slab, unit or the like of a magnetic material or material that exhibits a magnetic field. The magnetically responsive actuator 260 can be formed from a material that can be reactive to magnetic forces applies to the magnetically responsive actuator 260 from an external magnetic force.

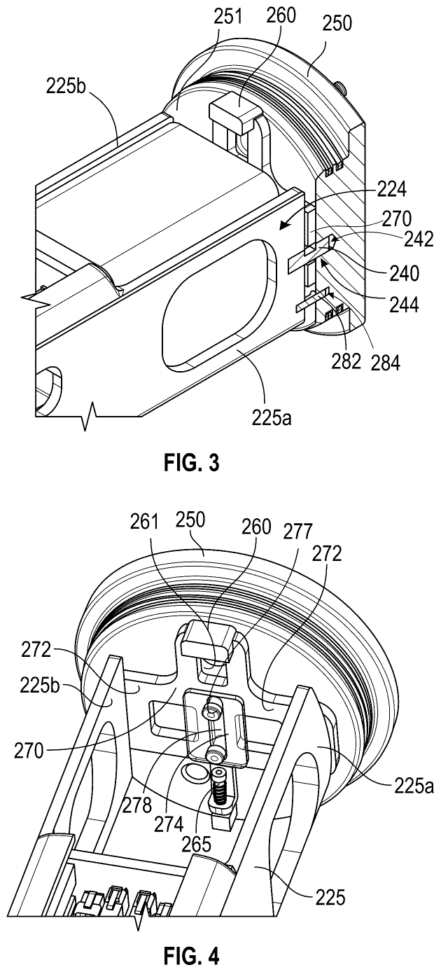

Illustrated in FIG. 3 and FIG. 4 is an example of a magnetic actuated latch 205. The magnetic actuated latch 205 can include the magnetically responsive actuator 260, the locking plate 270, the one or more chassis clasp 240 and the corresponding portions of the locking plate 270, such as a locking catch 244 for receiving the one or more chassis clasp 240.

The coupling cover 250 can be coupled with the chassis 225, such as with first brace 225a. For example, a first end portion 224 of the chassis 225 can include one or more chassis clasp 240. The first end portion 224 can also include one or more alignment pins 282. The one or more chassis clasp 240 and the one or more alignment pins 282 can be separate elements that are each, separately, coupled with the first end portion 224. For example, the one or more chassis clasp 240 and the one or more alignment pins 282 can be coupled within recesses, cavities, or the like proximate to the first end portion 224. For example, the one or more chassis clasp 240 and the one or more alignment pins 282 can be protrusions, extensions or the like that are positioned along the first end portion 224. The one or more chassis clasp 240 or the one or more alignment pins 282 can also be formed as a unitary piece with the chassis 225. For example, the one or more chassis clasp 240 or the one or more alignment pins 282 can be molded with the chassis 225 to extend from the first end portion 224. A similar arrangement, or another arrangement, of the one or more chassis clasp 240 or the one or more alignment pins 282 can be formed at an opposite end of the chassis 225. The one or more chassis clasp 240 or the one or more alignment pins 282 can also be formed in the second brace 225b of the chassis 225.

The coupling cover 250 can have a chassis clasp recess 242 that can extend into the coupling cover 250. For example, the chassis clasp recess 242 can extend into the coupling cover 250 at a position corresponding with the one or more chassis clasp 240 extending from the chassis 225. The coupling cover 250 can also include an alignment recess 284 that can extend into the coupling cover 250 at a position corresponding with the one or more alignment pins 282 extending from the chassis 225. The chassis clasp recess 242 or the alignment recess 284 can extend a predetermined amount into the coupling cover 250 to receive the one or more chassis clasp 240 or the one or more alignment pins 282, respectively.

The locking plate 270 can be positioned on the internal side 251 of the coupling cover 250. The locking plate 270 can have a recess, hole, cavity or the like extending through a portion corresponding to the chassis clasp recess 242 or the alignment recess 284. For example, the chassis 225 can be properly aligned with the coupling cover 250 by inserting at least one of the one or more chassis clasp 240 or the one or more alignment pins 282 through the locking plate 270 and into the chassis clasp recess 242 or the alignment recess 284, respectively.

As illustrated in FIG. 4, the first brace 225a and the second brace 225b can be coupled (e.g., joined, connected or the like) to the locking plate 270. The first brace 225a and the second brace 225b can be coupled to the locking plate 270 at or relative to one or more arms 272. The first brace 225a and the second brace 225b can be couple with a continuous structure of the locking plate 270. For example, the locking plate 270 can be a square, rectangle, or other polygon, or rounded or circular onto which the chassis 225 is coupled.

The locking plate 270 can be coupled with the coupling cover 250 with a retaining plate 274. The retaining plate 274 can be coupled with the coupling cover 250 so the locking plate 270 can shift positions relative to the coupling cover 250. In one example, the locking plate 270 can include a retention track 278 (e.g., rail, groove, recess, cavity, hole or the like). The retention track 278 can receive one or more retention carriages 277. The one or more retention carriages 277 can be coupled with the retaining plate 274. The one or more retention carriages 277 can restrict movement of the retaining plate 274 while allowing controlled movement of the locking plate 270. The one or more retention carriages 277 can travel within the retention track 278 to control the motion of the locking plate 270 relative to the 250.

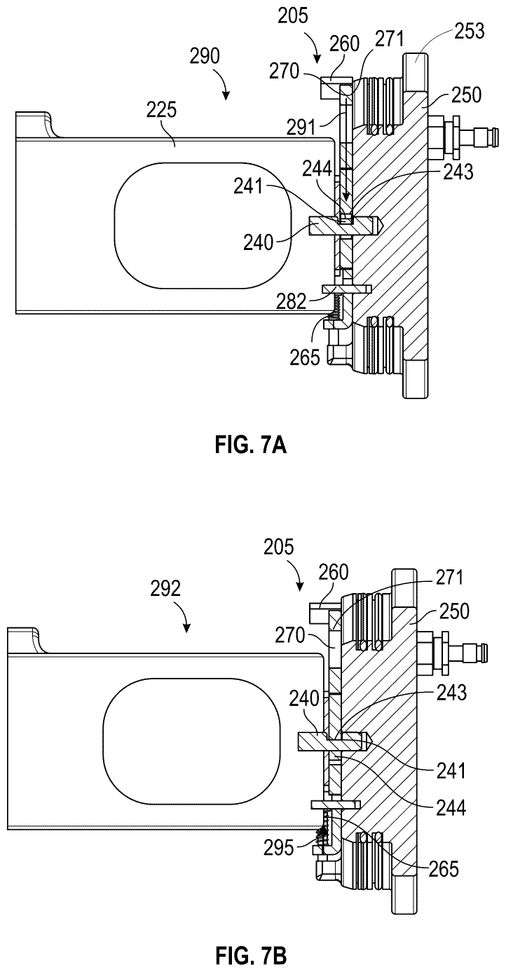

The magnetically responsive actuator 260 can be coupled with the locking plate 270 to initiate movement of the locking plate 270. The magnetically responsive actuator 260 can be coupled with the locking plate 270 with an adhesive, fastener, welding or the like. The magnetically responsive actuator 260 can be positioned with in an actuator receiving cavity 261. The actuator receiving cavity 261 can be a recess, slot, gap, indentation, niche or the like. The actuator receiving cavity 261 can be formed within the locking plate 270 at locations according to specified designs. In an example, the actuator receiving cavity 261 can be formed proximate to an outer perimeter 271 or removed a specified distance from the outer perimeter 271. The magnetically responsive actuator 260 can be positioned proximate to the outer perimeter 271 of the locking plate 270. In some instances, the magnetically responsive actuator 260 can be positioned closer to the interior portions of the locking plate 270. The magnetically responsive actuator 260 can be positioned proximate to the outer perimeter 271 and coupled with the locking plate 270 to transmit a force to the locking plate 270, as described relative to FIGS. 7A and 7B below.

A biasing member 265 (e.g., spring, elastic members or the like) can be positioned along the locking plate 270 at a position opposite to the magnetically responsive actuator 260. The biasing member 265 can provide a restoring force to move the locking plate 270 into the locked position unless acted upon by an external magnetic force. For example, the magnetically responsive actuator 260 can be positioned proximate to a first side of the outer perimeter 271 of the locking plate 270 and the biasing member 265 can be positioned proximate to an opposite side of the outer perimeter 271 of the locking plate 270. The biasing member 265 can be positioned along portions of the locking plate 270 to provide an opposing force to the movement of the magnetically responsive actuator 260 (as will be described related to FIGS. 7A and 7B). The biasing member 265 can be coupled with one or both of the locking plate 270 or the coupling cover 250. For example, the biasing member 265 can be coupled with the coupling cover 250 and received within a portion of the locking plate 270. The biasing member 265 can be movably coupled with the locking plate 270 and statically coupled with the coupling cover 250.

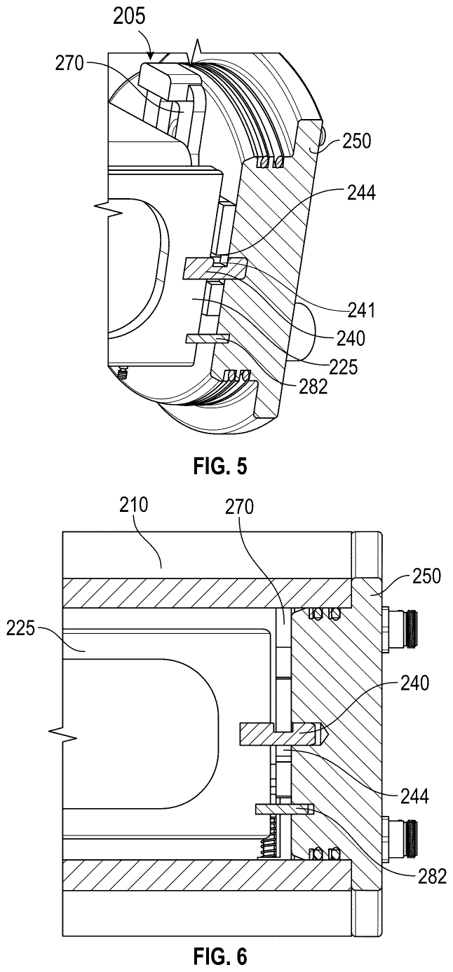

FIG. 5 and FIG. 6 illustrate an example of the one or more chassis clasp 240 passing through the locking plate 270. The one or more chassis clasp 240 can be received within the chassis clasp recess 242 of the coupling cover 250. The portion of the locking plate 270 through which the one or more chassis clasp 240 passes can be a locking catch 244. The locking catch 244 can be a through hole sized to receive and allow movement of the one or more chassis clasp 240 as the coupling cover 250 shifts positions. The size and profile of the locking catch 244 can provide a specified amount of clearance for the one or more chassis clasp 240 when the one or more chassis clasp 240 is inserted through the locking catch 244.

The one or more chassis clasp 240 can include a retention groove 241. The retention groove 241 can be formed with a similar length as the width of the locking plate 270. The length of the retention groove 241 can be formed to receive at least a portion of the locking plate 270. For example, the retention groove 241 can have a corresponding profile to receive at least a portion of the locking plate 270.

FIGS. 5 and 6 illustrate examples of an arrangement of the chassis 225 positioned in relationship to the locking plate 270. For example, the chassis 225 can be positioned in contact with the locking plate 270 or removed from the locking plate 270. The chassis 225 can be removed by a few millimeters to a centimeter from the locking plate 270. The chassis 225 can be positioned in contact with the locking plate 270.

The one or more chassis clasp 240 or the one or more alignment pins 282 can position the chassis 225 relative to the coupling cover 250 and the locking plate 270. The one or more alignment pins 282 can position the chassis 225 relative to the coupling cover 250 and the locking plate 270 so the one or more chassis clasp 240 is appropriate aligned within the locking catch 244. For example, the one or more alignment pins 282 can be at least partially inserted into the alignment recess 284 with a portion of the one or more alignment pins 282 exposed between the coupling cover 250 and the chassis 225. The exposed portion of the one or more alignment pins 282 can correspond to the width of the locking plate 270. The one or more alignment pins 282 can be positioned below at least a portion of the locking plate 270, such as relative to the one or more arms 272.

FIGS. 7A and 7B illustrate a method of locking the locking plate 270 and releasing (e.g., unlocking, detaching, decoupling or the like) the locking plate 270 using the magnetic actuated latch including the combination of the magnetically responsive actuator 260, the one or more chassis clasp 240 and the locking plate 270. FIG. 7A illustrates an example of a released configuration 290. FIG. 7B illustrates an example of a locked configuration 292.

In the released configuration 290, the chassis 225 is positioned relative to the locking plate 270 with the chassis clasp recess 242 in a position to allow the one or more chassis clasp 240 to be moved into and out of the chassis clasp recess 242. The chassis 225 including the one or more chassis clasp 240 and the one or more alignment pins 282 can be positioned relative to the alignment recess 284 and the one or more chassis clasp 240 can be positioned relative to the chassis clasp recess 242. The chassis 225 can be maneuvered so the one or more chassis clasp 240 can be received within the chassis clasp recess 242 and the one or more alignment pins 282 can be received in the alignment recess 284.

In the released configuration 290, the retention groove 241 of the one or more chassis clasp 240 is spaced from the locking catch 244. The one or more chassis clasp 240 can be spaced from a catch wall 243 of the locking catch 244. The one or more chassis clasp 240 can be spaced from the catch wall 243 so the one or more chassis clasp 240 can be positioned (e.g., slid, shifted, moved) within the locking catch 244. In an example, in the released configuration, the one or more chassis clasp 240 can be disconnected (e.g., released, decoupled, or the like) form the locking catch 244.

The biasing member 265 can be in a released configuration and does not provide a biasing force to the locking plate 270. The biasing member 265 can be coupled with the coupling cover 250 and positioned relative to the locking plate 270. For example, the biasing member 265 can be positioned relative to the locking plate 270 to allow free or controlled movement of the locking plate 270. The locking plate 270 in the released configuration 290 can allow the coupling cover 250 to be removed from the hull shell 210 (as discussed related to FIGS. 1 and 2A).

In the released configuration 290, the magnetically responsive actuator 260 can be positioned closer to an edge portion of the 250 than a central portion of the coupling cover 250. The biasing member 265, coupled with the locking plate 270, can be in a relaxed configuration with minimized tensive or compressive force applied to the biasing member 265 or the locking plate 270 in one position.

FIG. 7B illustrates an example of a locked configuration 292 of the locking plate 270. In the locked configuration 292, the magnetically responsive actuator 260 can be shifted inward from a position proximate to the outer perimeter 253 of the coupling cover 250. In the locked configuration 292 the retention groove 241 can be engaged with the catch wall 243. For example, the position of the one or more chassis clasp 240 assists in maintaining the position of the locking plate 270 such that the coupling cover 250 cannot be removed from the hull shell 210.

In the locked configuration 292 the biasing member 265 can apply a force 295 in a direction opposite to the direction of movement of the locking plate 270. For example, the biasing member 265 can provides the restoring force to move the locking plate 270 into the locked position unless acted upon by the external magnetic force. The biasing member 265 can assist in retaining the locking plate 270 in a locked configuration. The biasing member 265 can maintain the position of the locking plate 270 with the one or more chassis clasp 240 in engagement with the catch wall 243 of the one or more chassis clasp 240. When the one or more chassis clasp 240 is retained with the locking plate 270, the locking plate 270 can be deter the locking plate 270 from shifting position. Since the locking plate 270 can be coupled with the coupling cover 250 and the one or more chassis clasp 240 can be coupled with the chassis 225, the coupling cover 250 can be retained in position relative to the chassis 225.

The locking plate 270 can be transitioned to a locked configuration upon insertion of the one or more chassis clasp 240 into the locking catch 244. For example, the locking catch 244 upon insertion into the locking catch 244 the biasing member 265 have a force applied to compress the biasing member 265 and allow the locking plate 270 to correspondingly shift position. Upon completion of insertion of the locking catch 244 into the one or more chassis clasp 240 the force applied to the biasing member 265 can be released and can cause the locking plate 270 in a locked position with the one or more chassis clasp 240 engaged with the chassis clasp recess 242, forming the locked configuration 292. In the locked configuration 292 the coupling cover 250 can be connected with the hull shell 210.

In the locked configuration 292 the coupling cover 250 can be in a sealed relationship with the hull shell 210. The sealed relationship between the coupling cover 250 and the hull shell 210 can protect the internal components such as the electronic components 226 or payloads 227 from environmental conditions. The sealed relationship between the coupling cover 250 and the hull shell 210 with the magnetic actuated latch 205 can minimize stress forming areas of the hull shell 110 due to fasteners, threading, or other coupling features.

To transition the magnetic actuated latch 205 from the locked configuration 292 to the released configuration 290, an external magnetic element can be positioned external to the hull shell 210. The external magnetic element can be oriented proximate to the exterior surface of the coupling cover in a location relative to the magnetically responsive actuator 260. The external magnetic element can draw the magnetically responsive actuator 260 from the locked configuration 292 toward the outer perimeter 253 of the coupling cover 250. The external magnetic element can cause the magnetically responsive actuator 260 to shift positions.

When the magnetically responsive actuator 260 shifts positions toward the outer perimeter 253, the locking plate 270 can also be shifted so the outer perimeter 271 of the locking plate 270 can be closer to the outer perimeter 253 of the coupling cover 250. When the locking plate 270 shifts position 291, the locking catch 244 can be shifted. The shifted locking catch 244 can cause a gap to form between the catch wall 243 and the one or more chassis clasp 240. The gap between the one or more chassis clasp 240 and the catch wall 243 can disconnect (e.g., release, uncouple or the like) the engagement between the one or more chassis clasp 240 and the locking catch 244.

When the locking plate 270 can shift positions 291 toward the internal side 251 the coupling cover 250 applies a compressive force to the biasing member 265. The compressive force to the biasing member 265 can cause the locking plate 270 to overcome the opposing force applied to the locking plate 270 in the locked configuration 292.

The sealed relationship between the coupling cover 250 and the hull shell 210 can be released when the external magnetic element is positioned relative to the magnetically responsive actuator 260 to release the magnetic actuated latch 205 from the locked configuration 292. The coupling cover 250 can be removed from the chassis 225 or the hull shell 210 when the one or more chassis clasp 240 is not engaged with the locking catch 244.

### Aspects

Aspect 1 can include subject matter such as a magnetic actuated coupling latch comprising: a locking plate coupled with a coupling cover including a locking catch recess formed within a portion of the locking plate; a magnetically responsive actuator coupled to a portion of the locking plate; a biasing element coupled with a portion of the locking plate remote from the magnetically responsive actuator; and a chassis clasp configured to engage with the locking catch recess; wherein the locking plate is configured to transition from a released configuration to a locked configuration; wherein in the released configuration, the chassis clasp is configured to be removed from the locking catch; wherein in the locked configuration, the magnetically responsive actuator shifts a position of the locking plate to engage the locking catch recess with the chassis clasp.

Aspect 2 can include, or can optionally be combined with the subject matter of Aspect 1, to optionally include the one or more the biasing element is configured to apply a force to the locking plate.

Aspect 3 can include, or can optionally be combined with the subject matter of one or any combination of Aspects 1 or 2 to optionally include the locking plate is configured transition with an application of a magnetic force to the magnetically responsive actuator.

Aspect 4 can include, or can optionally be combined with the subject matter of one or any combination of Aspects 1 to 3 to optionally include the one or more the chassis clasp is statically coupled with a chassis and the locking catch recess configured to be shifted to an engagement arrangement with the chassis clasp.

Aspect 5 can include, or can optionally be combined with the subject matter of one or any combination of Aspects 1 to 4 to optionally include the one or more the magnetically responsive actuator is coupled proximate to an edge portion of the locking plate.

Aspect 6 can include, or can optionally be combined with the subject matter of one or any combination of Aspects 1 to 5 to optionally include the one or more the biasing element positioned on an opposed portion from the magnetically responsive actuator; wherein the biasing element receives an opposing force when the locking plate transitions between the locked configuration and the released configuration.

Aspect 7 can include subject matter such as a system for connecting a coupling cover with a hull shell, comprising: a shell architecture positioned within the hull shell, the shell architecture including: a chassis extending within the hull shell; and a chassis clasp extending from the chassis; a locking plate configured to be movably coupled with the coupling cover, the locking plate including: a locking catch recess formed in the locking plate and the locking catch recess is configured to receive the chassis clasp; and a magnetically responsive actuator coupled with the locking plate.

Aspect 8 can include, or can optionally be combined with the subject matter of Aspect 7, to optionally include a biasing element coupled with both the locking plate and the coupling cover; wherein the biasing element is configured to apply a force to the locking plate.

Aspect 9 can include, or can optionally be combined with the subject matter of one or any combination of Aspects 7 or 8 to optionally include the locking plate is configured to move from a released configuration to a locked configuration when a magnetic force is applied to the magnetically responsive actuator; wherein in the released configuration the chassis clasp is configured to be removed from the locking catch recess; wherein in the locked configuration the chassis clasp is engaged with the locking catch recess.

Aspect 10 can include, or can optionally be combined with the subject matter of one or any combination of Aspects 7 to 9 to optionally include the locked configuration the coupling cover is sealed against the hull shell.

Aspect 11 can include, or can optionally be combined with the subject matter of one or any combination of Aspects 7 to 10 to optionally include the coupling cover and the hull shell are formed from a non-ferrous material.

Aspect 12 can include, or can optionally be combined with the subject matter of one or any combination of Aspects 7 to 11 to optionally include the locking plate is configured to move from a released configuration to a locked configuration by applying a magnetic force through the coupling cover to the magnetically responsive actuator; wherein the magnetically responsive actuator is configured to apply a force to the locking plate and transition the position of the locking plate.

Aspect 13 can include, or can optionally be combined with the subject matter of one or any combination of Aspects 7 to 12 to optionally include a biasing element is coupled with the locking plate; wherein the locking plate is configured to move from a released configuration to a locked configuration by applying a magnetic force through the coupling cover to the magnetically responsive actuator; wherein in the released configuration the chassis clasp is configured to be removed from the locking catch recess; wherein in the locked configuration the chassis clasp is configured to be engaged with the locking catch recess and the coupling cover is configured to be in a sealed arrangement with the hull shell; and wherein in the locked configuration, the biasing element is configured to apply a force to the locking plate to retain the locking plate in the locked configuration.

Aspect 14 can include, or can optionally be combined with the subject matter of one or any combination of Aspects 7 to 13 to optionally include an alignment pin coupled with the chassis and an alignment recess formed in the coupling cover; wherein the alignment pin is configured to be positioned within the alignment recess.

Aspect 15 can include, or can optionally be combined with the subject matter of one or any combination of Aspects 7 to 14 to optionally include the shell architecture includes one or more of an electrical system, a computer system, or a payload.

Aspect 16 can include, or can optionally be combined with the subject matter of one or any combination of Aspects 7 to 15 to optionally include the coupling cover joins two adjacent hull shells.

Aspect 17 can include subject matter such as a method of connecting a coupling cover with a hull shell comprising: positioning the coupling cover against the hull shell, wherein the coupling cover includes: a locking plate movably coupled with the coupling cover, the locking plate including a locking catch recess formed in the locking plate; and a magnetically responsive actuator coupled with the locking plate; and wherein the hull shell includes: a chassis extending within the hull shell; and a chassis clasp extending from the chassis; positioning the chassis clasp within the locking catch recess; orienting an external magnetic element proximate to an exterior surface of the coupling cover in a location relative to the magnetically responsive actuator; and moving the magnetic element in a locking direction along the exterior surface of the coupling cover; wherein moving the magnetic element shifts the magnetically responsive actuator and the locking plate from a locked configuration to a release configuration; wherein in the released configuration, the chassis clasp is disconnected from the locking catch recess; and wherein in the locked configuration, the chassis clasp is engaged with the locking catch recess.

Aspect 18 can include, or can optionally be combined with the subject matter of Aspect 17, to optionally include sealing the coupling cover with the hull shell when the magnetically responsive actuator and the locking plate are in the locked configuration.

Aspect 19 can include, or can optionally be combined with the subject matter of one or any combination of Aspects 17 or 18 to optionally include applying a force to the locking plate with a biasing element; retaining the locking plate in the locked configuration with the biasing element.

Aspect 20 can include, or can optionally be combined with the subject matter of one or any combination of Aspects 17 to 19 to optionally include at least one of the coupling cover or the hull shell are formed from a non-ferrous material.

The above description includes references to the accompanying drawings, which form a part of the detailed description. The drawings show, by way of illustration, specific embodiments in which the disclosed concepts can be practiced. These embodiments are also referred to herein as “aspects” or “examples.” Such aspects or example can include elements in addition to those shown or described. However, the description also contemplates aspects or examples in which only those elements shown or described are provided. Moreover, the description also contemplates aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel,” “perpendicular,” “round,” or “square,” are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, subject matter may lie in less than all features of a particular disclosed embodiment. Thus, the following claims are hereby incorporated into the Detailed Description as aspects, examples, or embodiments, with each claim standing on its own as a separate embodiment, and it is contemplated that such embodiments can be combined with each other in various combinations or permutations. The scope of the disclosed concepts should be determined with reference to the appended claims, along with the full scope of equivalents to which such claims are entitled.

What is claimed is:

1. A magnetic actuated coupling latch comprising:
a locking plate coupled with a coupling cover including a locking catch recess formed within a portion of the locking plate;
a magnetically responsive actuator coupled to a portion of the locking plate;
a biasing element coupled with a portion of the locking plate remote from the magnetically responsive actuator; and
a chassis clasp configured to engage with the locking catch recess;
wherein the locking plate is configured to transition from a released configuration to a locked configuration;
wherein in the released configuration, the chassis clasp is configured to be removed from the locking catch recess;
wherein in the locked configuration, the magnetically responsive actuator shifts a position of the locking plate to engage the locking catch recess with the chassis clasp.

2. The magnetic actuated coupling latch of claim 1, wherein the biasing element is configured to apply a force to the locking plate.

3. The magnetic actuated coupling latch of claim 1, wherein the locking plate is configured transition with an application of a magnetic force to the magnetically responsive actuator.

4. The magnetic actuated coupling latch of claim 1, wherein the chassis clasp is statically coupled with a chassis and the locking catch recess configured to be shifted to an engagement arrangement with the chassis clasp.

5. The magnetic actuated coupling latch of claim 1, wherein the magnetically responsive actuator is coupled proximate to an edge portion of the locking plate.

6. The magnetic actuated coupling latch of claim 1, wherein the biasing element positioned on an opposed portion from the magnetically responsive actuator;
wherein the biasing element receives an opposing force when the locking plate transitions between the locked configuration and the released configuration.

7. A system for connecting a coupling cover with a hull shell, comprising:
a shell architecture positioned within the hull shell, the shell architecture including:
a chassis extending within the hull shell; and
a chassis clasp extending from the chassis;
a locking plate configured to be movably coupled with the coupling cover, the locking plate including:
a locking catch recess formed in the locking plate and the locking catch recess is configured to receive the chassis clasp; and
a magnetically responsive actuator coupled with the locking plate.

8. The system for connecting the coupling cover of claim 7, including:
a biasing element coupled with both the locking plate and the coupling cover;
wherein the biasing element is configured to apply a force to the locking plate.

9. The system for connecting the coupling cover of claim 7, wherein the locking plate is configured to move from a released configuration to a locked configuration when a magnetic force is applied to the magnetically responsive actuator;
wherein in the released configuration the chassis clasp is configured to be removed from the locking catch recess;
wherein in the locked configuration the chassis clasp is engaged with the locking catch recess.

10. The system for connecting the coupling cover of claim 9, wherein in the locked configuration the coupling cover is sealed against the hull shell.

11. The system for connecting the coupling cover of claim 7, wherein the coupling cover and the hull shell are formed from a non-ferrous material.

12. The system for connecting the coupling cover of claim 7, wherein the locking plate is configured to move from a released configuration to a locked configuration by applying a magnetic force through the coupling cover to the magnetically responsive actuator;
wherein the magnetically responsive actuator is configured to apply a force to the locking plate and transition the position of the locking plate.

13. The system for connecting the coupling cover of claim 7, including a biasing element is coupled with the locking plate;
wherein the locking plate is configured to move from a released configuration to a locked configuration by applying a magnetic force through the coupling cover to the magnetically responsive actuator;
wherein in the released configuration the chassis clasp is configured to be removed from the locking catch recess;
wherein in the locked configuration the chassis clasp is configured to be engaged with the locking catch recess and the coupling cover is configured to be in a sealed arrangement with the hull shell; and
wherein in the locked configuration, the biasing element is configured to apply a force to the locking plate to retain the locking plate in the locked configuration.

14. The system for connecting the coupling cover of claim 7, including an alignment pin coupled with the chassis and an alignment recess formed in the coupling cover;
wherein the alignment pin is configured to be positioned within the alignment recess.

15. The system for connecting the coupling cover of claim 7, wherein the shell architecture includes one or more of an electrical system, a computer system, or a payload.

16. The system for connecting the coupling cover of claim 7, wherein the coupling cover joins two adjacent hull shells.

17. A method of connecting a coupling cover with a hull shell comprising:
positioning the coupling cover against the hull shell,
wherein the coupling cover includes:
a locking plate movably coupled with the coupling cover, the locking plate including a locking catch recess formed in the locking plate; and
a magnetically responsive actuator coupled with the locking plate; and
wherein the hull shell includes:
a chassis extending within the hull shell; and
a chassis clasp extending from the chassis;
positioning the chassis clasp within the locking catch recess;
orienting an external magnetic element proximate to an exterior surface of the coupling cover in a location relative to the magnetically responsive actuator; and
moving the magnetic element in a locking direction along the exterior surface of the coupling cover;
wherein moving the magnetic element shifts the magnetically responsive actuator and the locking plate from a locked configuration to a released configuration;
wherein in the released configuration, the chassis clasp is disconnected from the locking catch recess; and
wherein in the locked configuration, the chassis clasp is engaged with the locking catch recess.

18. The method of connecting the coupling cover of claim 17, including sealing the coupling cover with the hull shell when the magnetically responsive actuator and the locking plate are in the locked configuration.

19. The method of connecting the coupling cover of claim 17, including applying a force to the locking plate with a biasing element;
retaining the locking plate in the locked configuration with the biasing element.

20. The method of connecting the coupling cover of claim 17, wherein at least one of the coupling cover or the hull shell are formed from a non-ferrous material.
